(19) United States
(12) Patent Application Publication
(10) Pub. No.: US 2011/0210691 A1
(43) Pub. Date: Sep. 1, 2011

(54) METHOD, MEASURING ARRANGEMENT AND APPARATUS FOR OPTICALLY MEASURING BY INTERFEROMETRY THE THICKNESS OF AN OBJECT

(76) Inventor: Francesco Ziprani, Firenze (IT)

(21) Appl. No.: 13/127,462

(22) PCT Filed: Nov. 13, 2009
(86) PCT No.: PCT/EP2009/065172

§ 371 Date: May 3, 2011

(30) Foreign Application Priority Data
Nov. 17, 2008 (IT) B02008A00694

(51) Int. Cl. G01B 11/06; G05B 1/06

(52) U.S. Cl. 318/640; 356/503

(57) ABSTRACT

Method, measuring arrangement (23;26;27) and apparatus (1) for optically measuring by interferometry the thickness of an object (2) having an external surface (16) and an internal surface (17) opposite with respect to the external surface. A low coherence beam of radiations (I) is emitted, such beam being composed of a number of wavelengths within a band determined, by means of radiation sources (4a,4b;4c,4d;4ef) which can alternatively employ at least two different radiation beams belonging to differentiated bands, as depending on the thickness of the object, or a single wide band radiation source. The radiation beam is directed onto the external surface of the object by means of an optical probe (6). The radiations (R) that are reflected by the object are caught by means of the optical probe. By means of spectrometers (5;5a,5b;5d,5e;5f,5g) it is possible to analyze the spectrum of the result of the interference between radiations (R1) that are reflected by the external surface without entering the object and radiations (R2) that are reflected by the internal surface entering the object; and the thickness of the object is determined as a function of the spectrum provided by the spectrometers. The two spectrometers can be alternatively used for radiations belonging to each of said differentiated bands.

### TECHNICAL FIELD

The present invention relates to a method, a measuring arrangement and an apparatus for optically measuring by interferometry the thickness of an object.

The present invention can be advantageously applied for optically measuring by interferometry the thickness of slices, or wafers, of semiconductor material (typically, but not necessarily, silicon), to which reference will be explicitly made in the specification without loss of generality.

### BACKGROUND ART

A slice of semiconductor material is machined, for example, to obtain integrated circuits or other electronic components in the semiconductor material. In particular, when the slice of semiconductor material is very thin, the slice of semiconductor material is placed on a support layer (typically made of plastic or glass) which provides a higher mechanical sturdiness, and thus an ease in handling. Generally, it is necessary to mechanically machine the slice of semiconductor material by grinding and polishing for obtaining a thickness condition that is regular and corresponds to a desired value. In the course of this mechanical machining phase of the slice of semiconductor material it is necessary to measure or keep under control the thickness so to obtain the desired value.

A known arrangement for measuring the thickness of a slice of semiconductor material employs gauging heads that have mechanical feelers touching an upper surface of the slice of semiconductor material being machined. This measuring technology may affect the slice of semiconductor material during the measuring operation owing to the mechanical contact with the mechanical feelers, and it doesn't allow to measure very small thickness values (typically smaller than 100 micron).

Other and different arrangements are known for measuring the thickness of a slice of semiconductor material such as capacitive probes, inductive probes (of the eddy-current type or other types), or ultrasound probes. These measuring technologies are of the contactless type, they do not affect the slice of semiconductor material in the course of the measuring and may measure the thickness of the slice of semiconductor material without the necessity of removing the support layer. However, some of these measuring technologies may offer a limited range of measurable dimensions, since typically thickness values being smaller than 100 micron may not be measured.

Optical probes, in some cases associated with interferometric measures, are used for overcoming the limits of the above described measuring technologies. For instance, U.S. Pat. No. 6,437,868 and the published Japanese patent application JP-A-08-216016 describe apparatuses for optically measuring the thickness of a slice of semiconductor material. Some of the known apparatuses include an infrared radiation source, a spectrometer, and an optical probe, which is connected to the infrared radiation source and to the spectrometer by means of optical fibers, it is placed in such a way to face the slice of semiconductor material to be measured, and it carries lenses for focusing the radiations on the slice of semiconductor material to be measured. The infrared radiation source emits a beam of infrared radiations for instance with a useful wavelength bandwidth located about 1300 nm, so constituting a low coherence beam. Low coherence opposes to monofrequency (single frequency being constant in time), being representative of the availability of a number of frequencies depending on the emissive principle implemented in the radiation source. Infrared radiations are employed since the currently used semiconductor materials are primarily made of silicon which is sufficiently transparent to the infrared radiations. In some of the known apparatuses, the infrared radiation source is composed of a SLED (Superluminescent Light Emitting Diode) which can emit a beam of infrared radiations having a bandwidth with an order of magnitude of about 50 nm around the central value.

However, even by using optical probes associated to interferometric measures of the above mentioned type, objects having thickness smaller than about 10 micron cannot be measured or checked—in the course of the mechanical machining phase thereof—with acceptable reliability, whereas the semiconductor industry is now requiring to measure thickness values of few or very few micron and to carry out the checking in the workshop environment and within the very limited time allowed by the machining cycles.

### DISCLOSURE OF THE INVENTION

The purpose of the present invention is to provide a method, a measuring arrangement and an apparatus for optically measuring by interferometry the thickness of an object which overcome the above described inconveniences, and can be concurrently easily and cheaply implemented.

The purpose is reached by a method, a measuring arrangement and an apparatus for optically measuring by interferometry the thickness of an object according to what is claimed in the accompanying claims.

### BRIEF DESCRIPTION OF THE DRAWINGS

The present invention is now described with reference to the enclosed sheets of drawings, given by way of non limiting example, wherein:

FIG. 1 is a simplified view, with some parts removed for the sake of clarity, of an apparatus according to the present invention for optically measuring by interferometry the thickness of a slice of semiconductor material;

FIG. 2 is a simplified cross-sectional side view of the slice of semiconductor material while the thickness of which is measured;

FIG. 3 is a simplified view, with some parts removed for the sake of clarity, of an infrared radiation source of the apparatus of FIG. 1;

FIG. 4 is a simplified view, with some parts removed for the sake of clarity, of a measuring arrangement according to the present invention for optically measuring by interferometry the thickness of a slice of semiconductor material;

FIG. 5 is a graph in connection with radiation absorption in a silicon slice;

FIG. 6 is a simplified view, with some parts removed for the sake of clarity, of a measuring arrangement according to a different embodiment of the present invention for optically measuring by interferometry the thickness of a slice of semiconductor material; and

FIG. 7 is a simplified view, with some parts removed for the sake of clarity, of a further measuring arrangement according to the present invention for optically measuring by interferometry the thickness of a slice of semiconductor material.

### BEST MODE FOR CARRYING OUT THE INVENTION

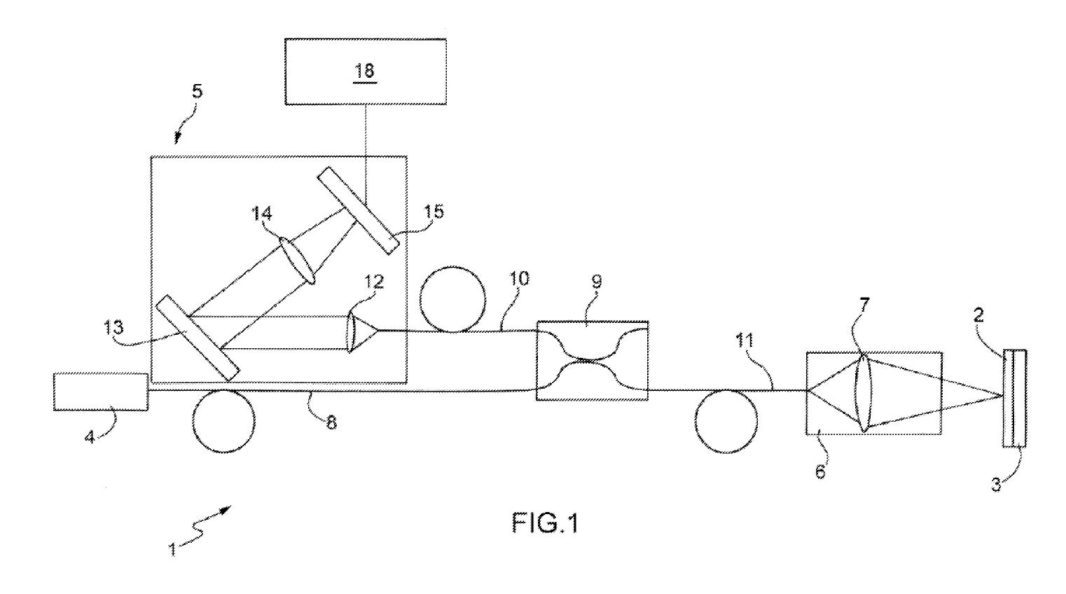

In FIG. 1, the reference number 1 indicates, on the whole, a measuring arrangement, more specifically an apparatus for optically measuring by interferometry the thickness of an object 2 formed by a slice of semiconductor material. It is to be noted herein and will be further explicated that the slice 2 is as well representative of a single layer and of a multiplicity of layers according to the various design requirements of the slice of semiconductor material.

According to the embodiment illustrated in FIG. 1 including per se known features, the slice 2 of semiconductor material is placed on a support layer 3 (typically made of plastic or glass) which provides for a higher mechanical sturdiness and ease in handling. According to a different embodiment, herein not illustrated, the support layer 3 is omitted.

The apparatus 1 includes an infrared radiation source 4, a spectrometer 5, and an optical probe 6 which is connected by means of optical fiber lines to the infrared radiation source 4 and to the spectrometer 5, it is arranged in such a way to face the slice 2 of semiconductor material to be measured, and it carries lenses 7 for focusing the radiations on the slice 2 of semiconductor material to be measured. Typically, the optical probe 6 is arranged in such a way to be perpendicular, as shown in FIG. 1, or slightly angled with respect to the external surface of the slice 2 of semiconductor material to be measured, the optical probe 6 being set apart from the latter by air or liquid or any other appropriate transmissive means, through which the infrared radiations propagate.

According to the embodiment shown in FIG. 1, there is a first optical fiber line 8 connecting the radiation source 4 to an optical coupler 9, a second optical fiber line 10 connecting the optical coupler 9 to the spectrometer 5, and a third optical fiber line 11 connecting the optical coupler 9 to the optical probe 6. The first 8, second 10 and third 11 optical fiber lines can end up at a circulator, which is per se known and thus not illustrated in FIG. 1, or at another device serving as the coupler 9.

According to the embodiment illustrated in FIG. 1, the spectrometer 5 includes at least a lens 12 collimating the radiations received through the second optical fiber line on a diffractor 13 (such as a grating or any other functionally equivalent device), and at least a further lens 14 focusing the radiations reflected by the diffractor 13 on a radiation detector 15 (typically formed by an array of photosensitive elements, for example an InGaAs sensor). The infrared radiation source 4 emits a low coherence beam of infrared radiations, which means that it is not monofrequency (a single frequency being constant in time), but it is composed of a number of frequencies.

Infrared radiations are employed in a preferred embodiment as the currently used semiconductor materials are primarily made of silicon, and silicon is sufficiently transparent to the infrared radiations.

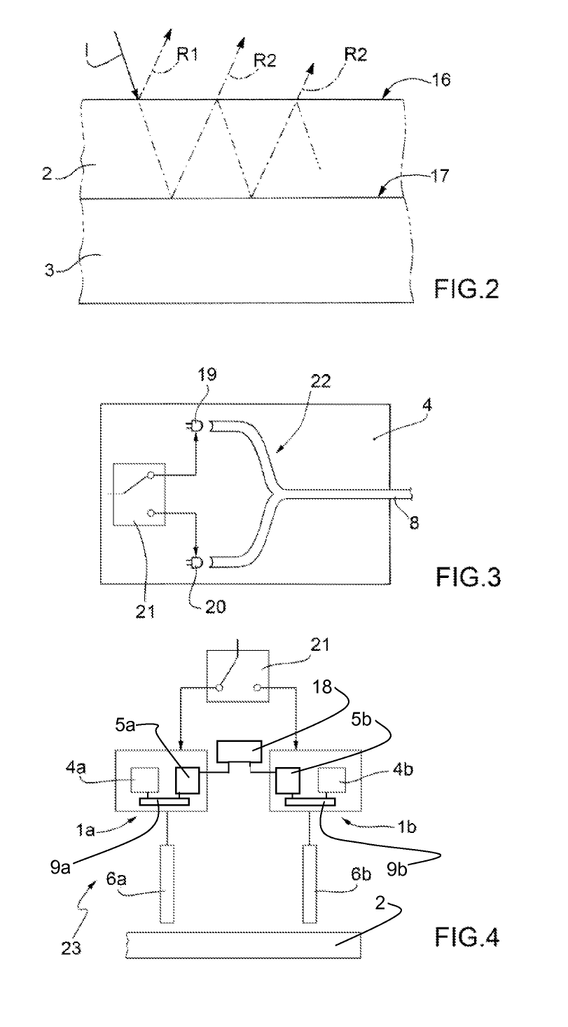

According to what is illustrated in FIG. 2 and is generally known, the optical probe 6 emits a beam of infrared radiations I directed onto the slice 2 of semiconductor material to be measured. Quotas of such radiations I (reflected radiations R1) are reflected back into the optical probe 6 by an external surface 16 without entering the slice 2 of semiconductor material. Other quotas of the infrared radiations I (reflected radiations R2) enter the slice 2 of semiconductor material and are reflected back into the optical probe 6 by an internal surface 17 opposite with respect to the external surface 16. It should be noted that, for the sake of understanding, in FIG. 2 the incident radiations I and the reflected radiations R are represented forming an angle other than 90° with respect to the attitude of the slice 2 of semiconductor material. In reality, as stated hereinbefore, these radiations—more specifically their propagation—can be perpendicular or substantially perpendicular to the attitude of the slice 2 of semiconductor material.

The optical probe 6 catches both the radiations R1 that have been reflected by the external surface 16 without entering the slice 2 of semiconductor material, and the radiations R2 that have been reflected by the internal surface 17 entering the slice 2 of semiconductor material.

As shown in FIG. 2, the radiations R2, that have been reflected by the internal surface 17 entering the slice 2 of semiconductor material, can leave the slice 2 of semiconductor material after just one reflection on the internal surface 17, after two subsequent reflections on the internal surface 17, or more generally, after a number N of subsequent reflections on the internal surface 17. Obviously, upon each reflection a quota of the radiations R2 leaves the slice 2 of semiconductor material through the external surface 16 until the residual intensity of the radiations R2 is almost null. It is to be noted that, by the same physics, energetic quotas may be lost as they are carried by radiations leaving the slice 2 of semiconductor material through the surface 17 into the support layer 3.

As previously stated, the beam of infrared radiations is composed of radiations having different frequencies (that is, having different wavelengths).

Given a nominal value for the thickness of the slice 2 of semiconductor material to be checked, the radiation frequencies available in the radiation source 4 are chosen so that there is certainly a radiation the wavelength thereof is such that twice the optical thickness of the slice 2 is equal to an integer multiple of the wavelength itself. The optical thickness is to be intended as the length of the transversal path of the radiation through the slice 2. As a consequence, this radiation when reflected by the internal surface 17, leaves the slice 2 of semiconductor material in phase with the radiation of the same wavelength reflected by the external surface 16, and is added to the latter so determining a maximum of interference (constructive interference). On the contrary, a radiation which has a wavelength being such that twice the optical thickness of the slice 2 of semiconductor material to be checked is equal to an odd multiple of the half-wavelength, when reflected by the internal surface 17 leaves the slice 2 of semiconductor material in antiphase with the radiation of the same wavelength reflected by the external surface 16, and is added to the latter so determining a minimum of interference (destructive interference).

The result of the interference between reflected radiations R1 and R2 is caught by the optical probe 6 and is conveyed to the spectrometer 5. The spectrum which is detected by the spectrometer 5 for each frequency (that is, for each wavelength) has a different intensity determined by the alternation of constructive and destructive interferences.

A processing unit 18 receives information representative of the spectrum from the spectrometer 5 and analyses it by means of some mathematical operations, per se known. In particular, by performing the Fourier analysis of the spectral information received from the spectrometer 5 and by knowing the refractive index of the semiconductor material, the processing unit 18 can determine the thickness of the slice 2 of semiconductor material.

Going into more details, in the processing unit 18 the received spectral information (as a function of the wavelength) can be mapped onto a periodic function and suitably processed, in a per se known way, as a periodic function which can be mathematically expressed by means of a Fourier series modeling. The characteristic interference pattern of the reflected radiations R1 and R2 expands as a sinusoidal function (wherein there is an alternation of constructive and destructive interference phenomena); the frequency of this sinusoidal function is proportional to the length of the optical thickness of the slice 2 of semiconductor material through which the radiation propagates. Eventually, by taking the Fourier transform of the aforementioned sinusoidal function, the value of the optical path through the slice 2 of semiconductor material and thus the optical thickness of the slice 2 of semiconductor material (corresponding to half the optical path) can be determined. The actual thickness of the slice 2 of semiconductor material can be easily obtained by dividing the optical thickness of the slice 2 of semiconductor material by the refractive index of the semiconductor material of the slice 2 (for example, the silicon refractive index amounts to about 3.5).

As hereinbefore described, the optical path (and thus the thickness) is determined on the basis of the frequency of the sinusoidal function. It can be shown by the application of known physical laws that the lower limit of the thickness value which can be directly measured is inversely proportional to the size of the continuous interval of wave numbers made available in the band of the used radiations, being the wave number the reciprocal of the wavelength.

According to what is illustrated in FIG. 3, the radiation source 4 includes an emitter 19 emitting a first low coherence radiation beam composed of a number of wavelengths within a first band, an emitter 20 emitting a second low coherence beam of radiations composed of a number of wavelengths within a second band differing from the first band, and a commutator 21 which alternatively enables to employ the emitter 19 or the emitter 20 as depending on the thickness of the slice 2 of semiconductor material. According to a preferred embodiment, the radiation source 4 includes an optical conveyor 22 comprising optical fibers which ends into the first optical fiber line 8 and is adapted to convey the radiation beams emitted by the two emitters 19 and 20 towards the first optical fiber line 8. For example, the optical conveyor 22 can be implemented by means of one or more couplers or circulators, per se known, in a way which is known and thus herein not illustrated in details. The commutator 21 can be implemented, for instance, by means of an optical switch which ends up at the emitters 19 and 20 at one end, and at the first optical fiber line 8 at the other end, or otherwise, as illustrated in simplified form in FIG. 3, as a device which alternatively switch on the emitter 19 or the emitter 20. In this embodiment, both the emitters 19 and 20 are always optically connected to the first optical fiber line 8, and the commutator 21 only acts on the electric control of the emitters 19 and 20 by enabling always just one emitter 19 or 20 at a time, whereas the other emitter 20 or 19 remains switched off.

In other words, by virtue of the action of the commutator 21 the radiation source 4 alternatively emits two different radiation beams having differentiated emissive bands—or bands—, as depending on the thickness of the object 2 to be checked. The first band of the first radiation beam emitted by the emitter 19 has a first central value which is greater than a second central value of the second band of the second radiation beam emitted by the emitter 20. The two emissive bands and their respective central values are purposefully chosen so as to result in the size enhancement of the continuous interval of wave numbers made available into the first optical fiber line 8 by virtue of a combination strategy herein described.

The commutator 21 enables the first emitter 19 when the thickness of the object 2 is greater than a predetermined threshold, and it enables the second emitter 20 when the thickness of the object 2 is smaller than the predetermined threshold. In such a way, the first radiation beam having the first band with the greatest first central value is used when the thickness of the object 2 is greater than the predetermined threshold; while the second radiation beam having the second band with the smallest second central value is used when the thickness of the object 2 is smaller than the predetermined threshold.

As an example, when the slice 2 of semiconductor material is made of silicon the first central value of the first band is within 1200 nm and 1400 nm, and the second central value of the second band is within 700 nm and 900 nm; moreover, in this case, the predetermined threshold is within 5 micron and 10 micron.

On the basis of theoretical considerations and experimental tests, it has been noted that by decreasing the central value of the wavelength band of the beam of the radiations I which is directed onto the slice 2 of semiconductor material (that is, by reducing the wavelength of the radiations I and consequently increasing the size of the continuous interval of wave numbers made available in the radiations I) it is possible to considerably decrease the limit defined by the smallest measurable thickness. It is to be noted that the wavelength reduction of the radiations I cannot exceed the constraints consequent to certain physical relations among the reflectance and the absorbance of the slice 2 of semiconductor material and the radiation wavelength, since by reducing the wavelength the transparency in the semiconductor material is reduced, too, and the resulting loss of radiation energy makes it more difficult to perform a proper measurement.

The present invention takes advantage of the fact that a semiconductor material is completely or almost completely opaque to radiations having wavelengths that are smaller than a certain lowest value. By decreasing the wavelength the portion of radiation entering the material decreases, and the thickness which the radiation can pass through also decreases, owing to the absorption phenomenon of the material.

However, when the thickness of the silicon slice is smaller than about 10 micron, the absorption contribution to the radiation energy loss lessens, making the silicon slice itself sufficiently transparent to (i.e. which can be passed through by) radiations having smaller wavelengths, even in the visible red, and beyond.

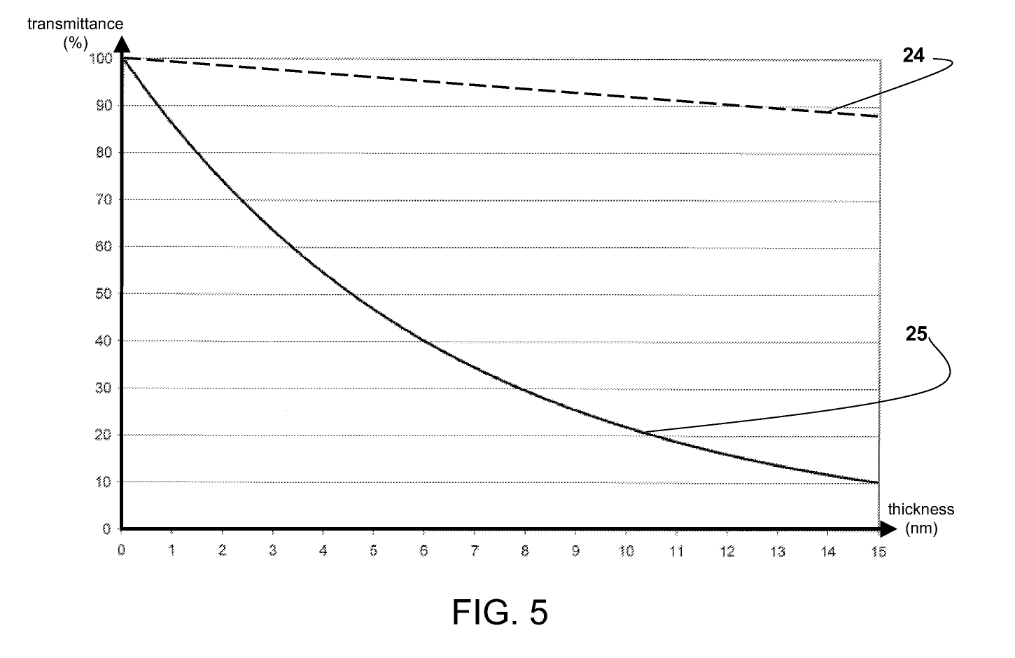

In connection with the above, the graph of FIG. 5 shows how the transmittance of radiations within the silicon slide varies—more specifically decreases—when the thickness of the latter increases. In FIG. 5, broken line 24 refers to a relatively longer wavelength (e.g. 1200 nm), while unbroken line 25 to a shorter wavelength (e.g. 826 nm). It is possible to note that the absorption phenomenon is negligible for long wavelengths and increases when the radiation wavelength decreases. However, as already stated above, when the thickness is small the slice is sufficiently transparent even to relatively short wavelengths radiations.

According to an additional feature of the present invention, the power of the second emitter 20 can be controlled, so that, in order to avoid that the radiation energy loss due to the absorption may jeopardize the achievement of proper results, such power be increased.

When the thickness of the slice 2 of semiconductor material is greater than the predetermined threshold the first emitter 19 emitting the first radiation beam having longer wavelengths is used.

When the thickness of the slice 2 of semiconductor material is smaller than the predetermined threshold, the emitter 20 emitting the second radiation beam having shorter wavelengths is used. The employ of the second radiation beam having shorter wavelengths (which is possible only when the thickness of the slice 2 of semiconductor material is small) enables to measure thickness values of the slice 2 of semiconductor material that are much smaller than the values measurable when the first radiation beam having longer wavelengths is used.

The commutator 21 can be manually controlled by an operator who sends control signals to the commutator 21, for example by means of a keyboard, depending on whether the expected thickness of the slice 2 of semiconductor material is greater or smaller than the predetermined threshold, and thus who controls the commutator 21 to activate the emitter 19 or the emitter 20. As an alternative, the commutator 21 can be automatically controlled by the processing unit 18.

In this case, the commutator 21 may be empirically controlled: the processing unit 18 causes the emitter 19 be enabled and checks if a reliable estimation of the thickness of the slice 2 of semiconductor material can be performed. In the affirmative and in case that the estimated thickness of the slice 2 of semiconductor material is greater than the predetermined threshold, the enabling of the emitter 19 is proper; whereas in the negative and/or in case that the estimated thickness of the slice 2 of semiconductor material is smaller (or even close to) the predetermined threshold, the processing unit 18 causes the emitter 20 be enabled (and the emitter 19 be disabled) and checks if a reliable estimation of the thickness of the slice 2 of semiconductor material can be performed. In the event two reliable estimations of the thickness of the slice 2 of semiconductor material can be performed by subsequently using the beams of both the emitters 19 and 20 (typically when the thickness of the slice 2 of semiconductor material is in a range around the predetermined threshold), the measured thickness of the slice 2 of semiconductor material is assumed as equal to one of the two evaluations, or it is assumed as equal to an average (in case a weighted average) between the two estimations.

As an example, in the embodiment shown in FIG. 3 the radiation source 4 includes two emitters 19 and 20; obviously there can be more than two emitters (typically not more than three or at the most four emitters).

For example, in the case of three emitters two threshold values are predetermined: when the thickness of the slice 2 of semiconductor material is greater than a first predetermined threshold a first emitter emitting a first radiation beam with a first band characterized with longer wavelengths is activated; when the thickness of the slice 2 of semiconductor material is within the two predetermined thresholds a second emitter emitting a second radiation beam with a second band characterized with intermediate wavelengths is activated; and when the thickness of the slice 2 of semiconductor material is smaller than a second predetermined threshold a third emitter emitting a third radiation beam with a third band characterized with shorter wavelengths is activated.

Preferably, each emitter 19 or 20 is formed by a SLED (Superluminescent Light Emitting Diode).

According to the embodiment shown in FIG. 3, there can be used a single apparatus 1 including the spectrometer 5, the optical probe 6, and the radiation source 4 which comprises in turn the two emitters 19 and 20 and the commutator 21 that alternatively activates the emitter 19 or the emitter 20 as depending on the thickness of the slice 2 of semiconductor material.

According to a different embodiment illustrated in FIG. 4, there is a measuring arrangement or station 23 which includes two separated apparatuses indicated in FIG. 4 with the reference numbers 1a and 1b, each apparatus comprising its own spectrometer 5a (and 5b), optical probe 6a (and 6b), optical coupler 9a (and 9b) and radiation source 4a (and 4b), and a commutator 21 which alternatively enables the apparatus 1a or the apparatus 1b as depending on the thickness of the object 2. Both spectrometers 5a and 5b are connected to the same processing unit 18 for determining the thickness of the slice 2 on the basis of the received spectrum. In this embodiment, the radiation source 4a of the apparatus 1a emits the first radiation beam composed of a number of wavelengths within the first band; while the radiation source 4b of the apparatus 1b emits the second radiation beam composed of a number of wavelengths within the second band differing from the first band. In the embodiment illustrated in FIG. 4, the two apparatuses 1 can even be always switched on (in this case the commutator 21 is omitted). Generally (that is, when the thickness of the slice 2 of semiconductor material is far from the predetermined threshold) just one of the two apparatuses 1a and 1b provides the processing unit 18 with a spectral information giving a reliable estimation of the thickness of the slice 2 of semiconductor material; whereas in particular cases (which means when the thickness of the slice 2 of semiconductor material is in a range around the predetermined threshold) both the apparatuses 1a and 1b provide the processing unit 18 with a spectral information giving a reliable estimation of the thickness of the slice 2 of semiconductor material. As previously disclosed, in this situation the measured thickness of the slice 2 of semiconductor material is assumed as equal to one of the two estimations, or it is assumed as equal to an average (in case a weighted average) between the two estimations.

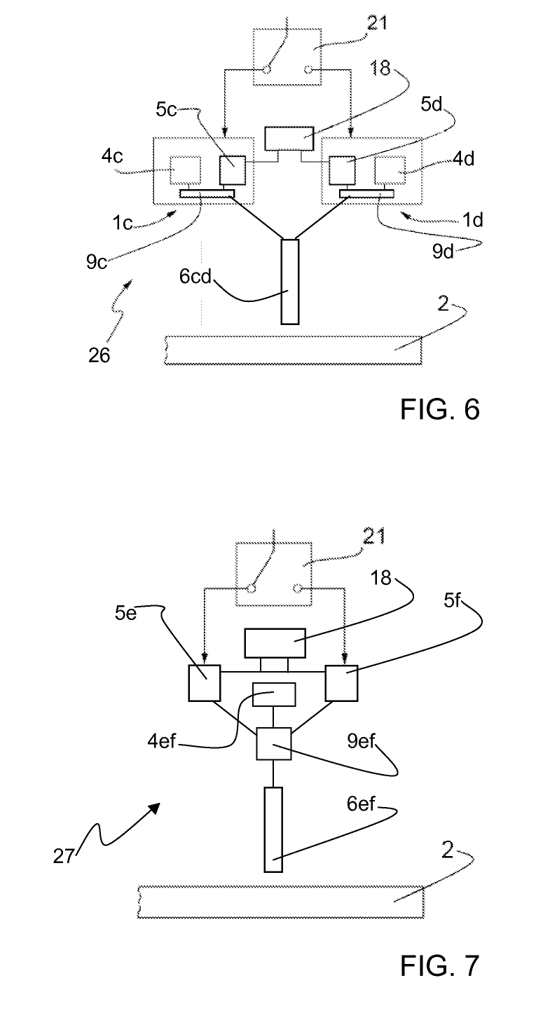

FIG. 6 shows a different measuring arrangement 26 according to the present invention. The measuring arrangement 26 is substantially similar to the station 23 of FIG. 4, but it includes two separate assemblies indicated with numbers 1c and 1d and a single optical probe 6cd, instead of two fully separate apparatuses. Spectrometers 5a, 5b, optical couplers 9c, 9d and radiation sources 4c, 4d are shown in FIG. 6 for each assembly 1c, 1d. The operation of the measuring arrangement 26 is similar to the one of station 23, and commutator 21 alternatively enables the assembly 1c or the assembly 1d as depending on the thickness of the object 2. Radiation sources 4c and 4d are able to emit first and second radiation beams with wavelengths within two different bands, e.g. the above mentioned first band with the first central value and the above mentioned second band with the second central value smaller than the first central value, respectively. First spectrometer 5c and second (or additional) spectrometer 5d are different from each other, including e.g different diffractor gratings and radiation detectors having each the proper features for operating with radiations having wavelength in said first and, respectively, second band.

Another measuring arrangement 27 according to the present invention is shown in FIG. 7. The measuring arrangement 27 substantially includes an apparatus with a radiation source 4ef, an optical coupler 9ef, an optical probe 6ef, a first spectrometer 5e and a second or supplemental spectrometer 5f. The spectrometers 5e and 5f are substantially similar to spectrometers 5c and, respectively, 5d of measuring arrangement 26 (FIG. 6), i.e. each of them has the proper features for operating with radiations having wavelength in a first band or, respectively, separate second band, wherein the first central value of the first band is greater than the second central value of the second band. The radiation source 4ef emits radiations in a wide range of wavelengths, including the wavelengths of both the above mentioned first and second bands, and can include a single emitter, for example a halogen lamp or, preferably, a supercontinuum laser source, e.g. with a wavelength range between about 750 nm and over 1500 nm. The radiations generated by source 4ef are sent to optical probe 6ef, and the result of the interference (that takes place as explained above in connection with FIGS. 1 and 2) is conveyed back by probe 6ef to the spectrometers 5e and 5f, through the optical coupler 9ef. Depending on the nominal thickness of the object 2, e.g. whether such nominal thickness is greater or smaller than a predetermined threshold, the commutator 21 alternatively activates spectrometer 5e or 5f having the proper features. Similarly to what happens for the arrangements 23 and 26 of FIGS. 4 and 6, the spectrometers 5e and 5f are coupled to the processing unit 18 for determining the thickness of the slice 2 on the basis of the received spectrum.

In a slightly different embodiment, the commutator 21 (e.g. an optical switch) can be placed at the output of the optical coupler 9ef, to convey the result of the interference alternatively to the spectrometer 5e or to the spectrometer 5f, depending on whether the nominal thickness of the object 2 is greater or smaller than the predetermined threshold.

The example shown in FIG. 2 refers to the particular case of a single slice 2 of semiconductor material placed on a support layer 3. However, applications of a method, a measuring arrangement and an apparatus according to the present invention are not limited to the dimensional checking of pieces of this type. In fact, such methods and measuring arrangements can also be employed, for example, for measuring the thickness of one or more slices 2 of semiconductor material and/or of layers made of other materials located inside a per se known multilayer structure. Within the multilayer structure, the thickness of single slices 2 or layer can be measured, as well as the thickness of groups of adjacent slices 2 or layers.

The above described measuring arrangements 1, 23, 26 and 27 have many advantages since they can be easily and cheaply implemented, and especially they enable to measure thickness values that are definitely smaller than the ones measured by similar known apparatuses and measuring arrangements.

Moreover, the method and measuring arrangements according to the invention are particularly adapted to carry out checking and measuring operations in the workshop environment before, during or after a mechanical machining phase of an object 2 such as a slice of silicon material.

1. A method for optically measuring by interferometry the thickness of an object featuring an external surface and an internal surface opposite with respect to the external surface, the method includes the steps of:
emitting a low coherence beam of radiations composed of a number of wavelengths within a determined band by means of at least one radiation source;
directing the beam of radiations onto the external surface of the object by means of at least one optical probe;
collecting radiations that are reflected by the object by means of said at least one optical probe;
analyzing by means of at least one spectrometer a spectrum of the result of the interference between radiations that are reflected by the external surface without entering the object and radiations that are reflected by the internal surface entering the object; and
determining the thickness of the object as a function of the spectrum analyzed by said at least one spectrometer;
wherein at least two different beams of radiations belonging to differentiated bands are employed, or at least two spectrometers are employed, to analyze the spectrum of said result of the interference for radiations having differentiated wavelengths substantially belonging to said differentiated bands.

2. The method according to claim 1 where at least two beams of radiations are employed, including the further steps of:
employing a first beam of radiations composed of a number of wavelengths within a first band having a first central value when the thickness of the object is greater than a predetermined threshold; and
employing a second beam of radiations composed of a number of wavelengths within a second band having a second central value which is smaller than the first central value of the first band when the thickness of the object is smaller than the predetermined threshold.

3. The method according to claim 2 where at least two beams of radiations are employed, including the further step of employing both the beams of radiations when the thickness of the object is comprised in a range around the predetermined threshold.

4. The method according to claim 1 where at least two spectrometers are employed, including the further steps of:
employing one of said at least two spectrometers adapted to analyze the spectrum of radiations belonging to a first band having a first central value when the thickness of the object is greater than a predetermined threshold; and
employing the other of said at least two spectrometers adapted to analyze the spectrum of radiations belonging to a second band having a second central value which is smaller than said first central value when the thickness of the object is smaller than the predetermined threshold.

5. The method according to claim 2, wherein the central value of the first band is between 1200 nm and 1400 nm and the central value of the second band is between 700 nm and 900 nm.

6. The method according to claim 2, wherein the predetermined threshold is between 5 micron and 10 micron.

7. The method according to claim 1, where the object is checked while undergoing a mechanical machining phase, wherein one or the other of the two different beams of radiations or of the two spectrometers is employed as depending on the thickness of the object.

8. The method according to claim 1 where at least two spectrometers are employed, wherein a measuring arrangement including a single radiation source is employed.

9. The method according to claim 1, employing two distinct and independent apparatuses, each of which comprises a spectrometer, an optical probe, and a radiation source.

10. The method according to claim 1, wherein the object is a slice of semiconductor material.

11. The method according to claim 10, wherein the object is a silicon slice.

12. The method according to claim 1, wherein the beam of radiations is substantially perpendicularly directed onto the external surface of the object.

13. A measuring arrangement for optically measuring by interferometry the thickness of an object featuring an external surface and an internal surface opposite with respect to the external surface, the measuring arrangement comprising:
at least one radiation source emitting a low coherence beam of radiations composed of a number of wavelengths within a determined band;
a first spectrometer analyzing a spectrum of the result of the interference between radiations that are reflected by the external surface without entering the object and radiations that are reflected by the internal surface entering the object;
at least one optical probe which is connected by means of optical fiber lines to said at least one radiation source and to the spectrometer and is arranged in front of the object to be measured for directing the beam of radiations emitted by said at least one radiation source onto the external surface of the object and for collecting the radiations that are reflected by both the external and the internal surfaces of the object;
a processing unit that calculates the thickness of the object as a function of the spectrum analyzed by the spectrometer; and
an additional spectrometer coupled to said at least one optical probe,
said first spectrometer being adapted to analyze the spectrum of the result of the interference between reflected radiations composed of a number of wavelengths within a first band and having a first central value, and
said additional spectrometer being adapted to analyze the spectrum of the result of the interference between reflected radiations composed of a number of wavelengths within a second band and having a second central value.

14. The measuring arrangement according to claim 13, further comprising a commutator which activates said first spectrometer when the thickness of the object is greater than a predetermined threshold, and activates said additional spectrometer when the thickness of the object is smaller than a predetermined threshold.

15. The measuring arrangement according to claim 13, wherein said at least one radiation source includes:
a first radiation source adapted to emit a beam of radiations composed of a number of wavelengths within the first band; and
a second radiation source adapted to emit a beam of radiations composed of a number of wavelengths within the second band, said second band being different from the first band and said second central value being smaller than the first central value of the first band.

16. The measuring arrangement according to claim 13, wherein said at least one radiation source includes a single radiation source adapted to emit a beam of radiations in a range of wavelengths including the wavelengths of said first and second bands.

17. The measuring arrangement according to claim 13, with at least two measuring apparatuses, each of which comprises one radiation source and one of said first spectrometer and said additional spectrometer.

18. An apparatus for optically measuring by interferometry the thickness of an object featuring an external surface and an internal surface opposite with respect to the external surface, the apparatus comprising:
a radiation source emitting a low coherence beam of radiations composed of a number of wavelengths within a determined band;
at least one spectrometer analyzing a spectrum of the result of the interference between radiations that are reflected by the external surface without entering the object and radiations that are reflected by the internal surface entering the object;
an optical probe which is connected by means of optical fiber lines to the radiation source and to said at least one spectrometer, and is arranged in front of the object to be measured for directing the beam of radiations emitted by the radiation source onto the external surface of the object and for collecting the radiations that are reflected by both the external and the internal surfaces of the object; and
a processing unit that evaluates the thickness of the object as a function of the spectrum analyzed by the at least one spectrometer;
wherein the radiation source comprises:
a first emitter which emits said low coherence beam of radiations as a first beam of radiations composed of a number of wavelengths within a first band having a first central value;
at least a second emitter which emits said low coherence beam of radiations as a second beam of radiations composed of a number of wavelengths within a second band differing from the first band and having a second central value that is smaller than the first central value of the first band; and
a commutator which alternatively enables to employ the first emitter or the second emitter as depending on the thickness of the object.
